(19) United States
(12) Patent Application Publication
(10) Pub. No.: US 2024/0123526 A1
(43) Pub. Date: Apr. 18, 2024

(54) CIRCULAR SAW APPARATUS WITH AN INTEGRATED DUST COLLECTION SYSTEM

(71) Applicant: JPL GLOBAL, LLC, Perris, CA (US)

(72) Inventor: Paul W. Guth, Menifee, CA (US)

(21) Appl. No.: 18/488,946

(22) Filed: Oct. 17, 2023

Related U.S. Application Data
(60) Provisional application No. 63/416,904, filed on Oct. 17, 2022.

(51) Int. Cl. B23D 59/00; B23D 47/04; B23D 57/00

(52) U.S. Cl. CPC B23D 59/006; B23D 47/045; B23D 57/0092; B23D 59/001

(57) ABSTRACT

Various aspects to facilitate mobilizing bulk equipment are disclosed. In a first aspect, a saw apparatus includes a vacuum source, a worktable, and a portability mechanism integrated within the saw apparatus in which dimensions associated with the portability mechanism depend on a location of a center of mass of the saw apparatus. The worktable includes a center slot axially aligned to a circular saw blade, and the vacuum source is configured to provide a negative pressure beneath the worktable at the center slot. In a second aspect, a center of mass inquiry is received, which includes data associated with equipment having a non-uniform distribution of mass. The center of mass inquiry is then processed, and a portability mechanism adjustment is sent in response to a processing of the center of mass inquiry.

### CROSS-REFERENCE TO RELATED APPLICATIONS

This application claims the benefit of U.S. Provisional Patent Application Ser. No. 63/416,904, filed Oct. 17, 2022, which is titled “CIRCULAR SAW APPARATUS WITH AN INTEGRATED DUST COLLECTION SYSTEM” and its entire contents of which are incorporated herein by reference.

### TECHNICAL FIELD

The subject disclosure generally relates to dust collection, and more specifically to integrating a dust collection system within a circular saw apparatus.

### BACKGROUND

When using conventional power saws, the release of airborne dust and particulate matter resulting from cutting a workpiece is problematic. Health hazards associated with breathing in such dust are particularly problematic. The development of wet cutting devices is one solution to dust abatement, wherein water is applied at a blade cutting edge where dust is entrained to a fluid and directed to a holding area. While most wet-cutting methods work relatively well, they create additional problems of waste water pollution and environmental concerns. Conventional masonry and tile saws, for instance, typically have a tub or pan of water with a pump that supplies water to the cutting head. While the saw is cutting, the water is sprayed and dispersed around the saw cutting area. Therefore, because this water can drip, spray, and potentially spill, the power saw cannot be placed in close proximity to where the actual masonry and or tile installation is taking place. The user thus spends a significant amount of time walking back and forth between the power saw and the installation area.

Accordingly, a dry-operated power saw which prevents dust from escaping into the environment is desirable. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with a dust collection system. In one such aspect, a saw apparatus to facilitate mobilizing bulk equipment is disclosed, which includes a vacuum source, a worktable, and a portability mechanism integrated within the saw apparatus in which dimensions associated with the portability mechanism depend on a location of a center of mass of the saw apparatus. Within such embodiment, the worktable includes a center slot axially aligned to a circular saw blade, and the vacuum source is configured to provide a negative pressure beneath the worktable at the center slot.

In a further aspect, a method to facilitate ascertaining a portability mechanism adjustment is disclosed, which includes employing a processor to execute computer executable instructions stored on a computer readable storage medium to implement various acts. The acts of the method include receiving a center of mass inquiry, which includes data associated with equipment having a non-uniform distribution of mass. The acts of the method further include processing the center of mass inquiry, and sending a portability mechanism adjustment in response to a processing of the center of mass inquiry. Within such embodiment, the portability mechanism adjustment corresponds to an adjustment of dimensions associated with a portability mechanism that depends on a location of a center of mass of the equipment.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 is a block diagram of an exemplary apparatus that facilitates removing airborne dust via a filtration system in accordance with an aspect of the subject specification;

FIG. 2 is a schematic view of an exemplary apparatus with an integrated filtration system in accordance with an aspect of the subject specification;

FIG. 3 illustrates an exemplary environment that facilitates dust collection in accordance with an aspect of the subject specification;

FIG. 4 is a block diagram illustrating exemplary components of a management system in accordance with an aspect of the subject specification;

FIG. 5 is a schematic view of an exemplary single vacuum table saw with multiple dust collection zones in accordance with an aspect of the subject specification;

FIG. 6 is a top schematic view of the exemplary single vacuum table saw with multiple dust collection zones illustrated in FIG. 5;

FIG. 7 is a cross-sectional schematic view of the exemplary single vacuum table saw with multiple dust collection zones illustrated in FIG. 5;

FIG. 8 is a photo illustrating an exemplary opening in a side wall of a negative pressure housing in accordance with an aspect of the subject specification;

FIG. 9 is a flow diagram of an exemplary methodology that facilitates monitoring negative pressure levels within a saw apparatus in accordance with an aspect of the subject specification;

FIG. 10 is a schematic illustrating an exemplary motor housed within a cylindrical filter in accordance with an aspect of the subject specification;

FIG. 11 is a schematic illustrating a disassembled view of an exemplary motor and cylindrical filter in accordance with an aspect of the subject specification;

FIG. 12 is a schematic illustrating an exemplary vacuum fan coupled to a vacuum motor housed within a cylindrical filter in accordance with an aspect of the subject specification;

FIG. 13 is a schematic illustrating an exemplary cylindrical filter comprising filter media and a filter gear in accordance with an aspect of the subject specification;

FIG. 14 is a schematic illustration of an exemplary filter coupled to logic circuitry in accordance with an aspect of the subject specification;

FIG. 15 is a flow diagram of an exemplary methodology that facilitates monitoring sensors within a saw apparatus in accordance with an aspect of the subject specification;

FIG. 16 is a schematic illustrating exemplary portability mechanisms integrated within a saw apparatus in accordance with an aspect of the subject specification;

FIG. 17 is a schematic illustrating an exemplary stabilizing wheel in accordance with an aspect of the subject specification;

FIG. 18 is a flow diagram of an exemplary methodology that facilitates ascertaining a portability mechanism adjustment in accordance with an aspect of the subject specification;

FIG. 19 is a block diagram representing exemplary non-limiting networked environments in which various embodiments described herein can be implemented; and

FIG. 20 is a block diagram representing an exemplary non-limiting computing system or operating environment in which one or more aspects of various embodiments described herein can be implemented.

### DETAILED DESCRIPTION

### Overview

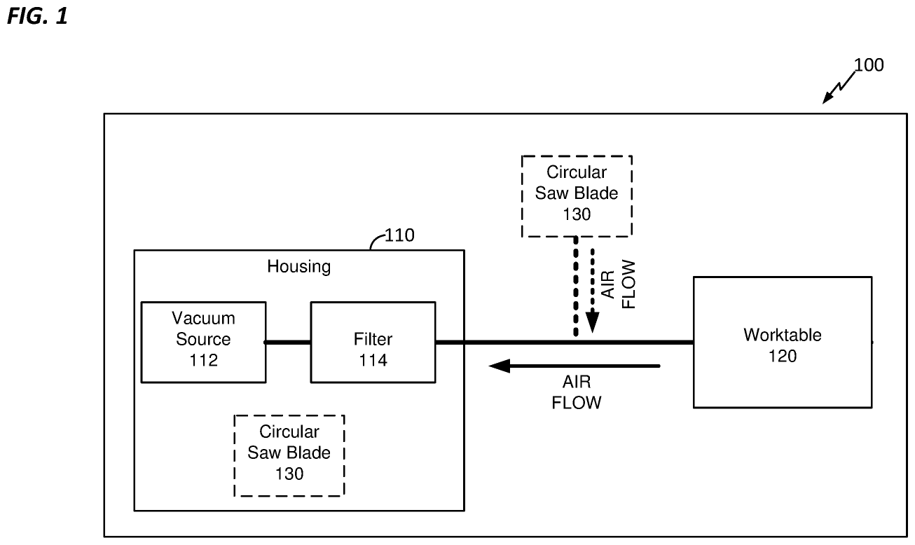

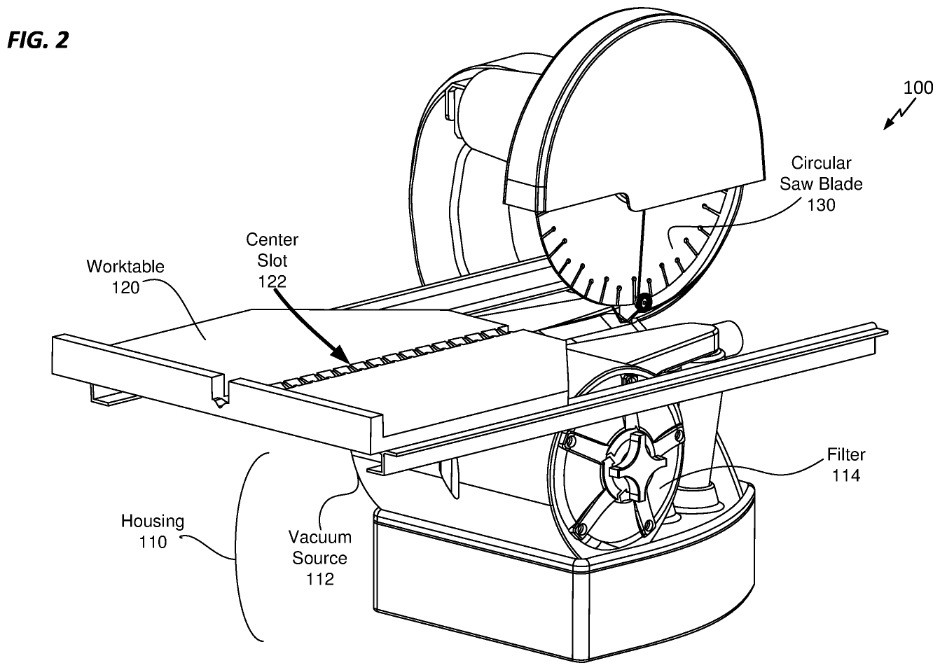

The various embodiments disclosed herein are directed toward integrating a dust collection system within a circular saw apparatus. In FIG. 1, a block diagram is provided of an exemplary apparatus that facilitates removing airborne dust in accordance with an aspect of the subject specification. As illustrated, apparatus 100 comprises a housing 110, a worktable 120, and a circular saw blade 130, wherein the housing 110 further comprises a vacuum source 112 and a filter 114. As illustrated in FIG. 2, it is contemplated that the worktable 120 will comprise a center slot 122 axially aligned to the circular saw blade 130, wherein the worktable 120 is configured to slide above the housing 110. During use, vacuum source 112 is configured to provide a negative pressure beneath the worktable 120 at the center slot 122, whereas filter 114 is configured to collect airborne dust drawn by the negative pressure from an area proximate to the center slot.

Various aspects of the circular saw apparatus 100 are contemplated and disclosed herein. For instance, in a first aspect, a single vacuum design with multiple dust collection zones is contemplated. In another aspect, a saw apparatus with a vacuum motor-in-filter design is contemplated. In yet another aspect, a saw apparatus with an integrated portability mechanism is contemplated.

### Exemplary Environment

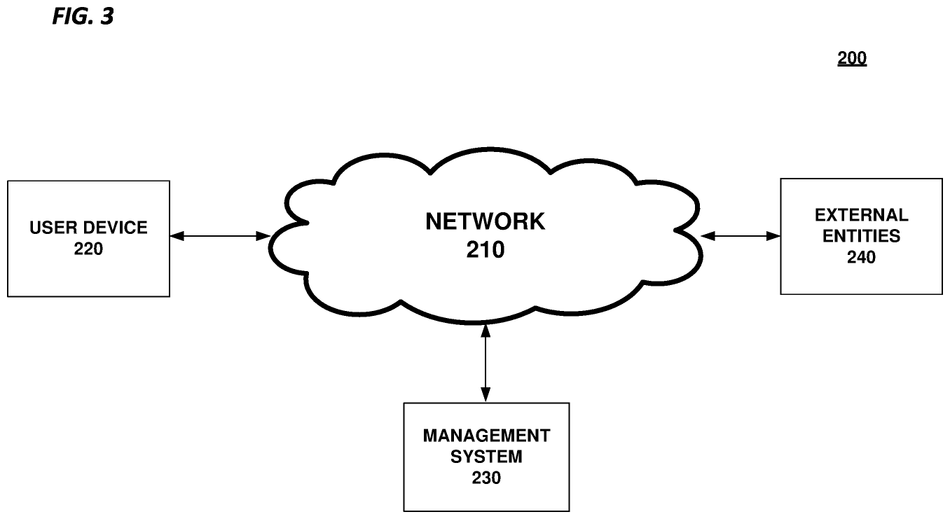

Referring next to FIG. 3, an exemplary environment that facilitates dust collection in accordance with an aspect of the subject specification is provided. As illustrated, environment 200 includes user device 220 and external entities 240, which are communicatively coupled to a management system 230 via a network 210 (e.g., the Internet). In a particular aspect, it is contemplated that management system 230 is a system comprising hardware and/or software components that may be configured to facilitate various dust collection aspects disclosed herein. It is further contemplated that any combination of hardware and/or software components of management system 230 may reside within a saw apparatus (e.g., circular saw apparatus 100) or external to a saw apparatus (e.g., circular saw apparatus 100).

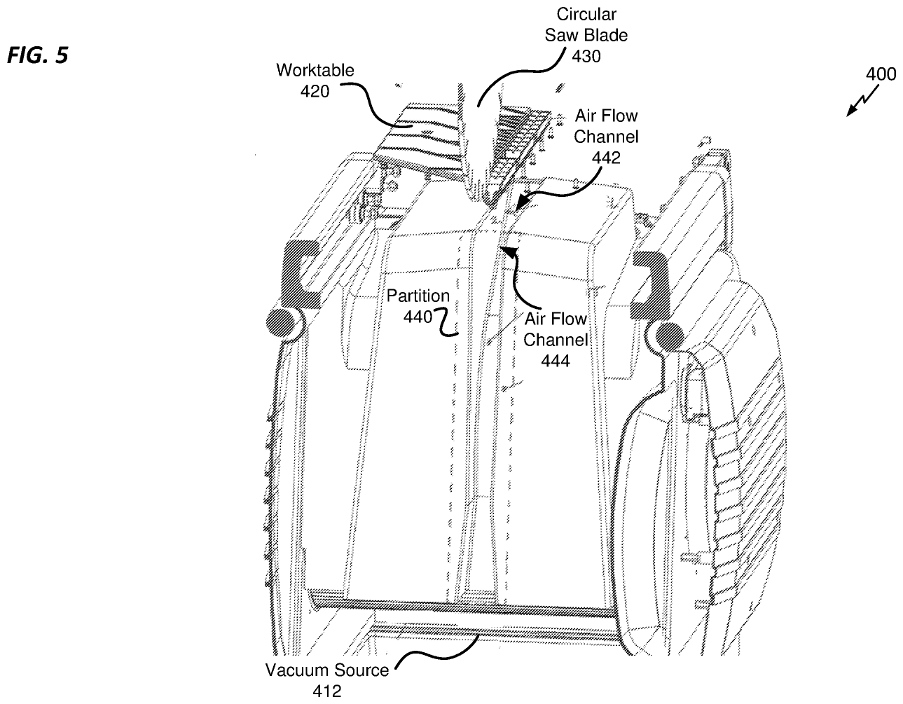

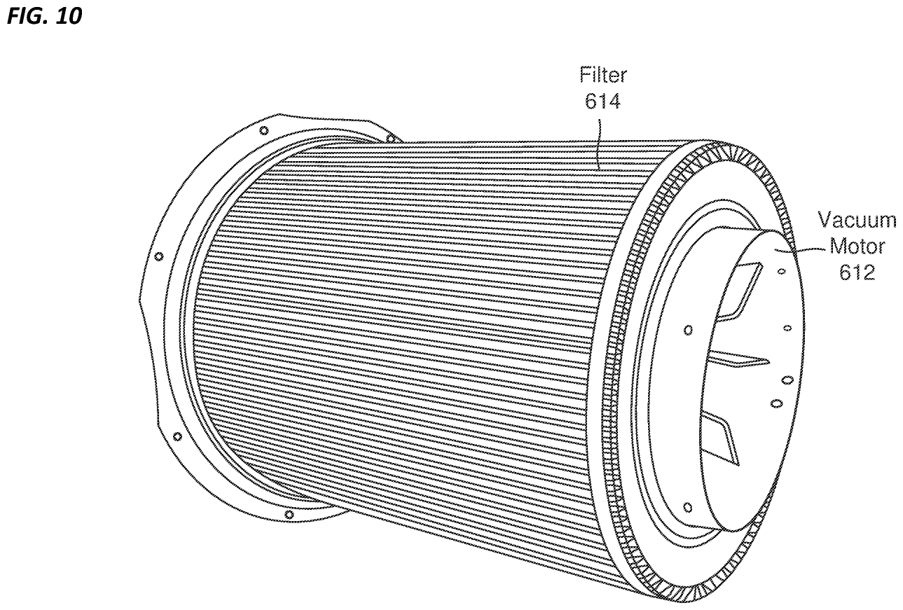

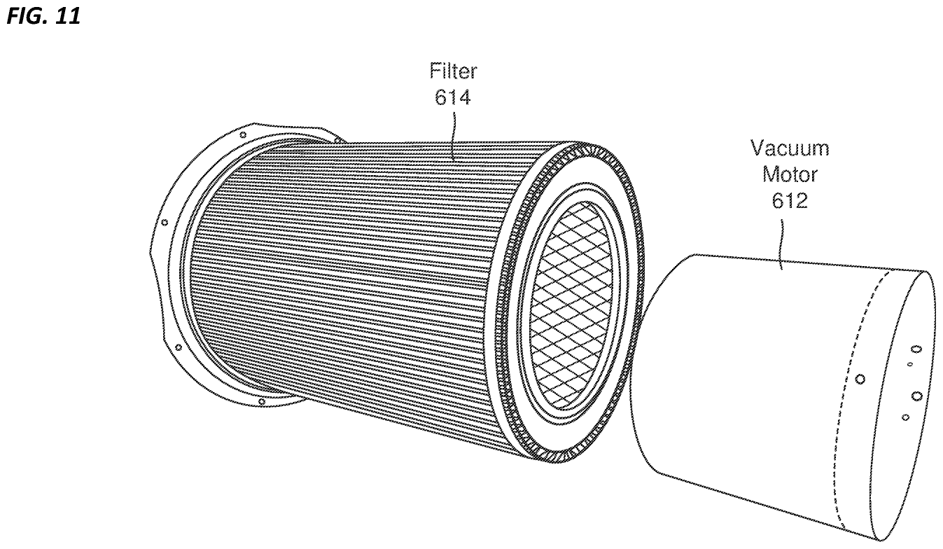

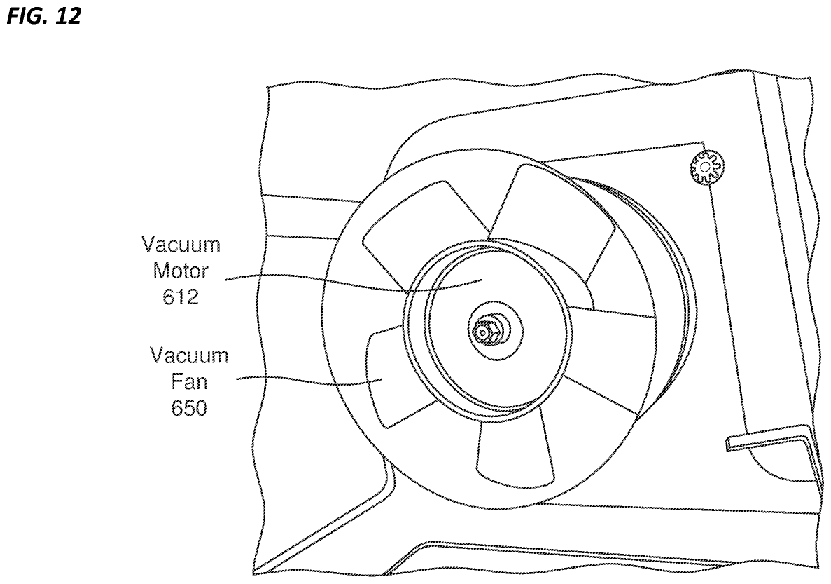

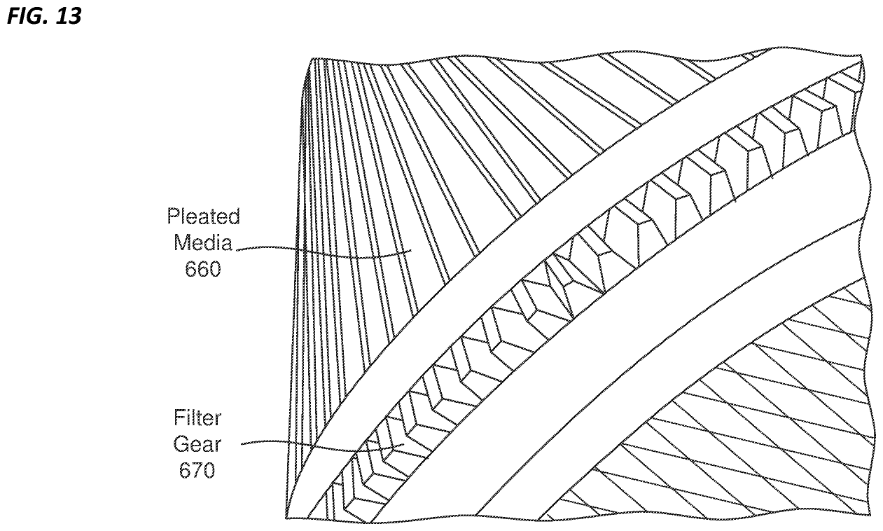

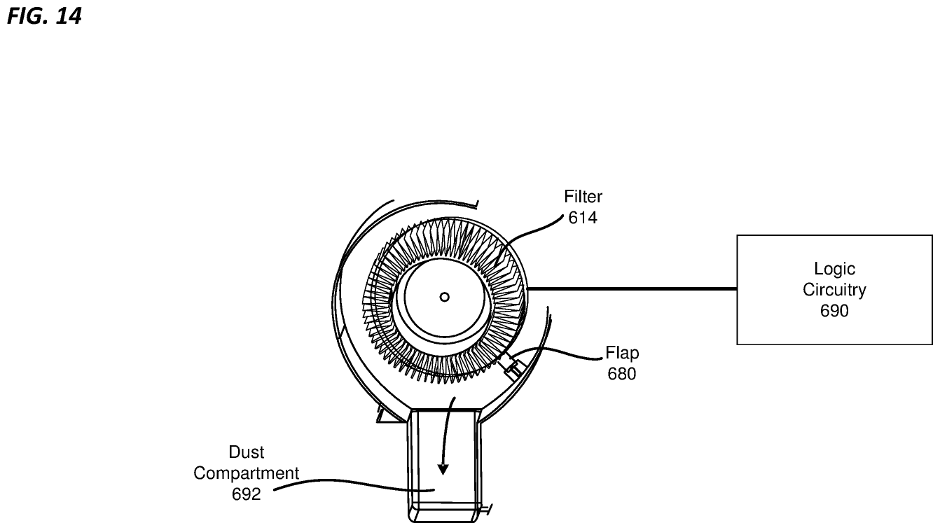

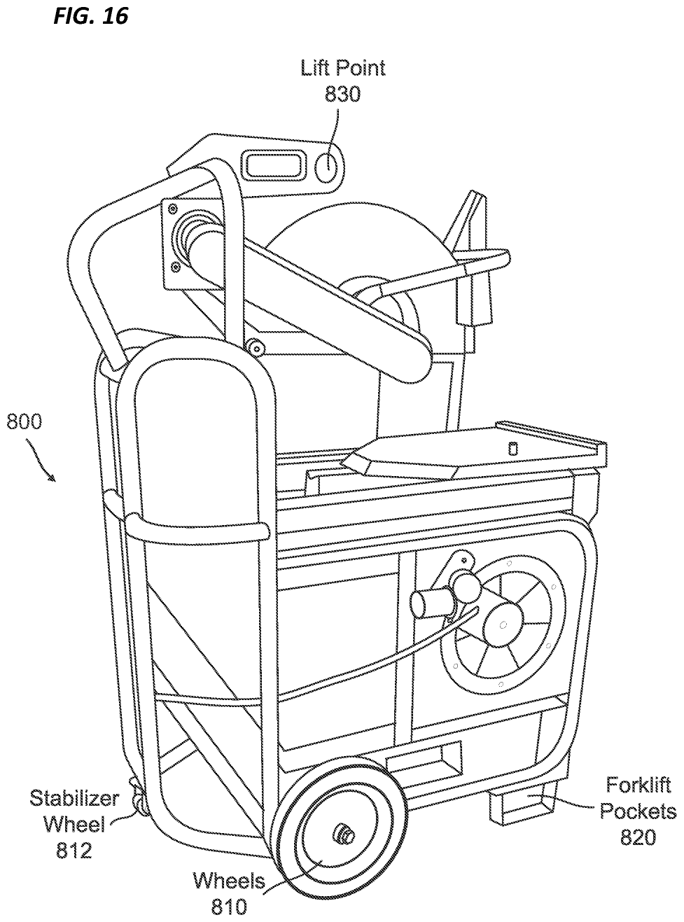

In an exemplary use case, it is contemplated that a user may monitor and/or control aspects of a saw apparatus (e.g., circular saw apparatus 100) by connecting with management system 230 via user device 220 (e.g., a smartphone, laptop, etc.). For instance, upon connecting with management system 230, a user may monitor and/or control aspects of: the saw apparatus disclosed below with reference to FIGS. 5-9; the saw apparatus with a vacuum motor-in-filter design disclosed below with reference to FIGS. 10-15; and/or the saw apparatus with an integrated portability mechanism disclosed below with reference to FIGS. 16-18.

### Exemplary Management System

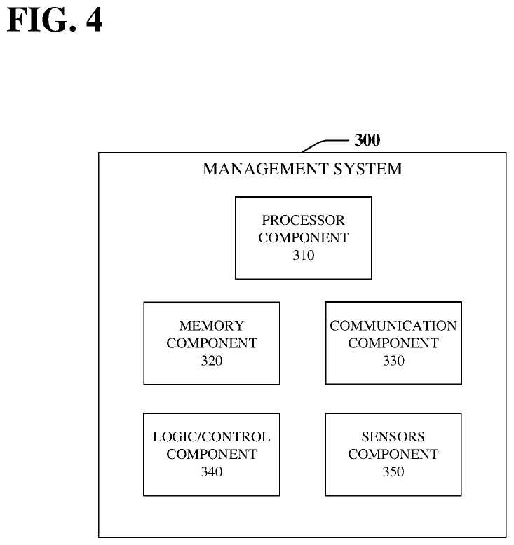

FIG. 4 shows a block diagram of an exemplary management system 300 which facilitates various aspects disclosed herein and which is substantially similar to management system 230. As shown in FIG. 4, management system 300 may include a processor component 310, a memory component 320, a communication component 330, a logic/control component 340, and a sensors component 350. Components 310-350 may reside together in a single location or separately in different locations in various combinations, including, for example, a configuration in which any of the aforementioned components reside in a cloud. For instance, with reference to FIG. 1, it is contemplated that these components may reside, alone or in combination, in computing devices corresponding to any of user device 220, management system 230, and/or external entities 240.

In one aspect, processor component 310 is configured to execute computer-readable instructions related to performing any of a plurality of functions. Processor component 310 can be a single processor or a plurality of processors which analyze and/or generate information utilized by memory component 320, communication component 330, logic/control component 340, and/or sensors component 350. Additionally, or alternatively, processor component 310 may be configured to control one or more components of management system 300.

In another aspect, memory component 320 is coupled to processor component 310 and configured to store computer-readable instructions executed by processor component 310. Memory component 320 may also be configured to store any of a plurality of other types of data including data generated by any of communication component 330, logic/control component 340, and/or sensors component 350. Memory component 320 can be configured in a number of different configurations, including as random access memory, battery-backed memory, solid state memory, hard disk, magnetic tape, etc. Various features can also be implemented upon memory component 320, such as compression and automatic back up (e.g., use of a Redundant Array of Independent Drives configuration). In one aspect, the memory may be located on a network, such as a “cloud storage” solution.

As illustrated, management system 300 may also comprise communication component 330 to facilitate communicating with user device 220 and/or external entities 240, for example. Management system 300 may also comprise logic/control component 340 to facilitate various logic and control aspects disclosed herein. Furthermore, management system 300 may comprise sensors component 350 to facilitate various sensor-related aspects disclosed herein.

### Exemplary Single Vacuum with Multiple Dust Collection Zones Embodiments

Within a cutting apparatus with integrated dust collection designed to cut specified materials there typically becomes areas or dust collection zones within the system that could utilize an increase in vacuum air velocity to be more effective as a system. For instance, in a table saw apparatus, a single vacuum may be used to create a first dust collection zone where dust is pulled through filters, and a second dust collection zone where dust is pulled from a point of contact between the saw and an item being cut. Here, it may be desirable to provide an increased vacuum air velocity in the second dust collection zone, relative to the first dust collection zone.

Various disclosed aspects are directed towards a table saw comprising multiple dust collection zones driven by a single vacuum source. In a particular aspect, a single vacuum table saw configuration with two dust collection zones is contemplated where one dust collection zone (e.g., at the point of contact) has a higher vacuum air velocity, relative to the other dust collection zone. Namely, it is contemplated that a higher vacuum air velocity can be achieved at the point of contact by inserting a cover plate between the point of contact and the vacuum source, which forms a “thinner” conduit between the point of contact and the vacuum source. The thinner geometry of this conduit allows the negative pressure created by the vacuum to be focused at the point of contact, which can have a vacuum velocity much higher (e.g., 2×) than a separate dust collection zone in which the vacuum pulls dust through filters.

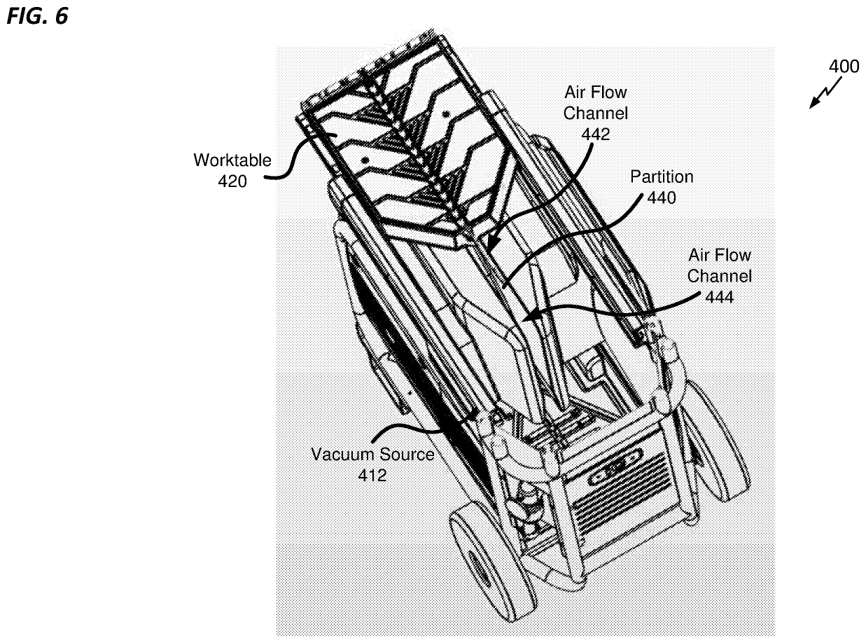

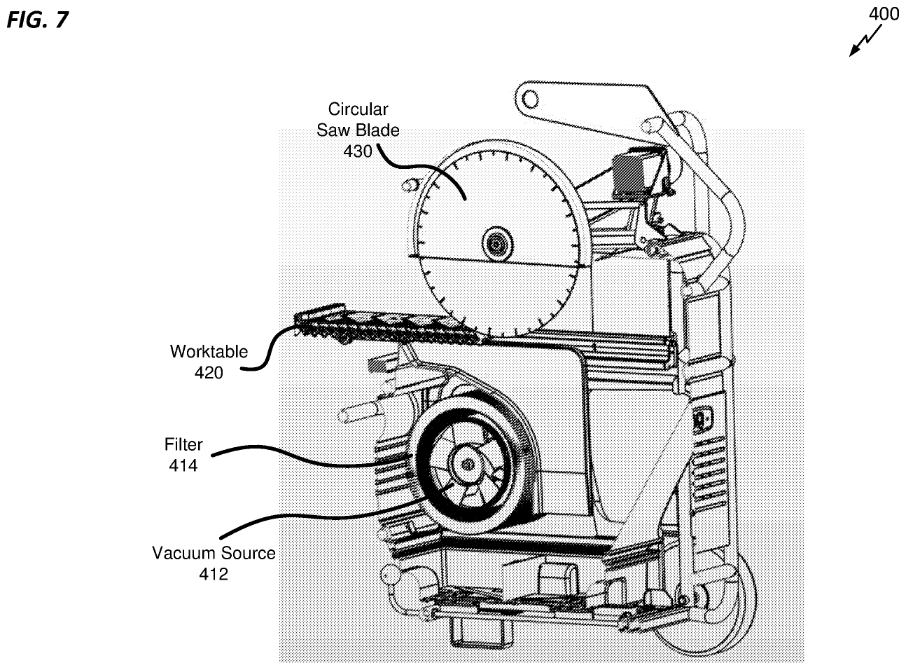

Referring next to FIG. 5, a schematic view is provided of an exemplary single vacuum table saw with multiple dust collection zones in accordance with an aspect of the subject specification. For further reference, FIG. 6 is a top schematic view of the exemplary single vacuum table saw illustrated in FIG. 5, whereas FIG. 7 is a cross sectional schematic view of the exemplary single vacuum table saw illustrated in FIG. 5. As illustrated, a saw apparatus is contemplated that is substantially similar to apparatus 100. Namely, a saw apparatus 400 is contemplated that comprises a vacuum source 412, a circular saw blade 430, a worktable 420 coupled to the vacuum source 412, wherein the vacuum source 412 is configured to provide a negative pressure region beneath the worktable 420. The saw apparatus may further comprise a partition 440 configured to divide the negative pressure region beneath the worktable 420 into a first negative pressure region via a first air flow channel 442 and a second negative pressure region via a second air flow channel 444, wherein a difference in dimensions between the first air flow channel 442 and the second air flow channel 444 facilitates a difference in pressure between the first negative pressure region and the second negative pressure region.

As illustrated, in a particular embodiment, the first negative pressure region is proximate to an anticipated point of contact between the circular saw blade 430 and a workpiece, wherein the partition 440 is a cover plate configured to provide the difference in dimensions between the first air flow channel 442 and the second air flow channel 444. It is also contemplated that the saw apparatus may further comprise a filter 414 coupled to the first air flow channel 442. For instance, as will be described in further detail below, the filter may be a cylindrical filter, wherein a motor (not pictured) is configured to power the vacuum source 412, and wherein the motor is housed within the cylindrical filter.

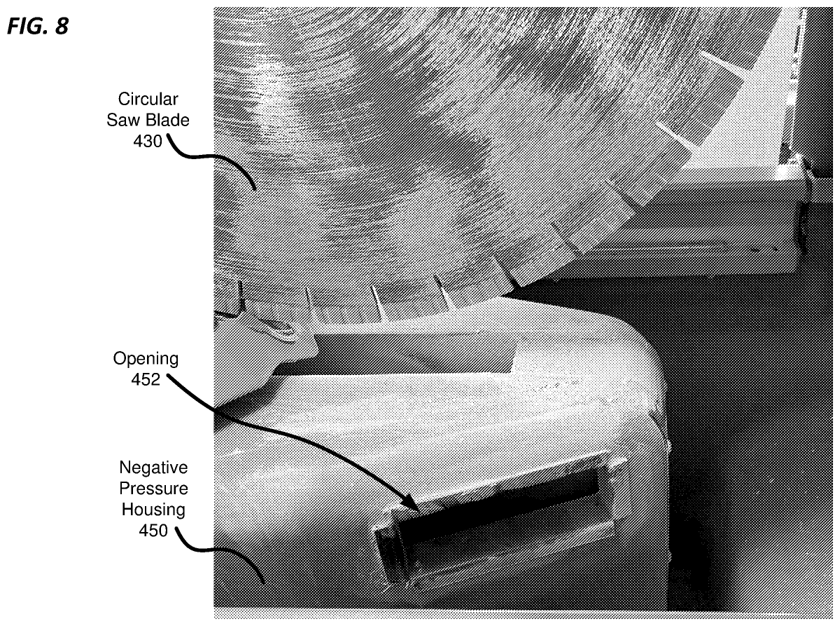

In another aspect, it is contemplated that the partition 440 is within a negative pressure housing (e.g., opening 452 illustrated in FIG. 8) of the worktable 420 that is coupled to the vacuum source 412, wherein the negative pressure housing comprises at least one opening (e.g., negative pressure housing 450 illustrated in FIG. 8) to further divide the negative pressure region beneath the worktable 420 into a third negative pressure region. For instance, the negative pressure housing may comprise a center slot axially aligned to the circular saw blade 430, wherein the first negative pressure region and the second negative pressure region provide negative pressure within the center slot, and wherein the third negative pressure region provides negative pressure outside of the center slot.

An illustration of an exemplary negative pressure housing is provided in FIG. 8. In a particular aspect contemplated herein, an apparatus includes a vacuum source 412, a circular saw blade 430, and a worktable 420 that includes a negative pressure housing 450. The negative pressure housing 450 may be coupled to the vacuum source 412 and configured to provide a plurality of negative pressure regions beneath the worktable 420.

In a first aspect, it is contemplated that the negative pressure housing 450 comprises a center slot axially aligned to the circular saw blade 430, wherein a first of the plurality of negative pressure regions is within the center slot, and wherein a second of the plurality of negative pressure regions is outside of the center slot. Within such embodiment, the negative pressure housing 450 may comprise an opening 452 on a side wall substantially perpendicular to the center slot, wherein the second of the plurality of negative pressure regions is outside of the center slot and proximate to the opening 452 on the side wall. Here, it is further contemplated that the negative pressure housing 450 may comprise a second opening on a second side wall (not shown) substantially perpendicular to the center slot, wherein a third of the plurality of negative pressure regions is outside of the center slot and proximate to the second opening on the second side wall.

In another aspect, the negative pressure housing 450 may comprise a partition 440 within a center slot axially aligned to the circular saw blade 430, wherein a first of the plurality of negative pressure regions is on a first side of the partition 440 within the center slot, and wherein a second of the plurality of negative pressure regions is on a second side of the partition 440 within the center slot. Here, it is further contemplated that the negative pressure housing 450 may comprise a first air flow channel on the first side of the partition 440 and a second air flow channel on the second side of the partition 440, wherein a difference in dimensions between the first air flow channel and the second air flow channel facilitates a difference in pressure between the first of the plurality of negative pressure regions and the second of the plurality of negative pressure regions.

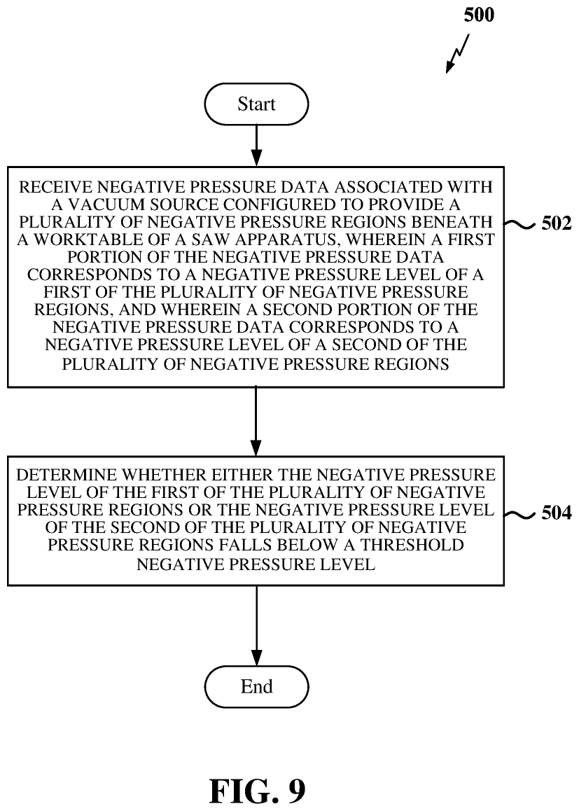

In yet another aspect, it is contemplated that at least one negative pressure sensor (e.g., represented by sensors component 350) may be configured to monitor a negative pressure level of at least one of the plurality of negative pressure regions. For instance, with reference to FIG. 9, a flow chart illustrating an exemplary method that facilitates monitoring negative pressure levels within a saw apparatus according to an embodiment is provided. As illustrated, process 500 includes a series of acts that may be performed by a management system that includes at least one computing device (e.g., management system 300) according to an aspect of the subject specification. For instance, process 500 may be implemented by employing a processor to execute computer executable instructions stored on a computer readable storage medium to implement the series of acts. In another embodiment, a computer-readable storage medium comprising code for causing at least one computer to implement the acts of process 500 is contemplated.

In an aspect, process 500 begins at act 502 with the management system 300 receiving negative pressure data associated with a vacuum source configured to provide a plurality of negative pressure regions beneath a worktable of a saw apparatus, wherein a first portion of the negative pressure data corresponds to a negative pressure level of a first of the plurality of negative pressure regions, and wherein a second portion of the negative pressure data corresponds to a negative pressure level of a second of the plurality of negative pressure regions. Process 500 then concludes at act 504 where the management system 300 determines whether either the negative pressure level of the first of the plurality of negative pressure regions or the negative pressure level of the second of the plurality of negative pressure regions falls below a threshold negative pressure level.

Various other aspects of process 500 are also contemplated. For instance, process 500 may further comprise providing an indication that at least one of the negative pressure level of the first of the plurality of negative pressure regions or the negative pressure level of the second of the plurality of negative pressure regions is below a threshold negative pressure level. For instance, the providing may comprise transmitting the indication to a remote entity via a network protocol. It is also contemplated that process 500 may comprise communicating an instruction to a user to manually clean a filter coupled to the vacuum source, and/or communicating an instruction to the saw apparatus to automatically clean a filter coupled to the vacuum source.

### Exemplary Motor-In-Filter Embodiments

Large-capacity air movers, or vacuums with dust filtration systems, are large and bulky which makes a system utilizing them very limited in application and portability. For instance, some of these apparatuses need a large amount of space (e.g., approximately 8 ft.³) to generate vacuum airflow and dust collection filtration to meet a performance threshold of 1000+ CFM of airflow, eight inches of water lift vacuum, and a 99%+ efficient filter. Large-capacity filtration systems would also desirably include a mechanism to clean the filter easily and seamlessly. Previous methods included utilizing compressed air, filter shaking, or some mechanism of agitation to release the dust from the filter media into a dust container.

Various disclosed aspects are directed towards a filter coupled to a vacuum source, wherein the vacuum motor is housed within the filter. In a particular embodiment, a cylindrical vacuum motor is housed within a cylindrical filter with pleated filter media, as shown in FIGS. 10-14. As illustrated, it is contemplated that vacuum motor 612 is housed within filter 614, wherein vacuum motor 612 is configured to power vacuum fan 650. Here, since the vacuum motor 612 is cylindrical in shape, it forms a spindle that the filter 614 can be sealed to and allow rotation for cleaning the pleated filter media 660 via an agitation flap 680. For instance, filter 614 may be configured to rotate manually, wherein contact between pleated filter media 660 and the agitation flap 680 as filter 614 is rotated releases dust that accumulates on filter 614 into a dust compartment 692.

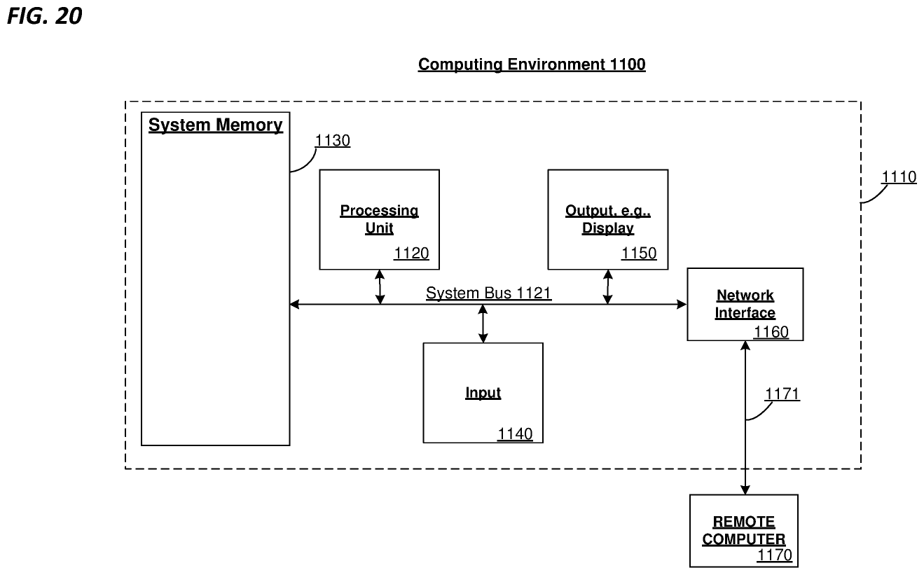

Alternatively, filter 614 may further comprise a gear 670 on one end mating to a motorized drive gear which can spin the filter 614 automatically via logic circuitry 690 in accordance with a programmable set of parameters (e.g., where logic circuitry 690 is programmable and/or controllable via a computing device, such as the computing device illustrated in FIG. 20). Indeed, a saw apparatus is contemplated that comprises a sensor component (e.g., represented by sensors component 350), wherein the logic circuitry (e.g., represented by logic/control component 340) is configured to auto-rotate the cylindrical filter in response to a trigger detected by the sensor component. Here, it should be appreciated that any of various triggers are contemplated (e.g., wherein the trigger is a threshold number of uses; a threshold amount of use time; and/or a threshold negative pressure level in a negative pressure region within the saw apparatus).

In another aspect, an apparatus is contemplated that includes a vacuum source, a vacuum motor configured to provide power to the vacuum source, and a rotatable filter configured to collect airborne dust drawn by a negative pressure created by the vacuum source. Here, the vacuum motor is housed within the rotatable filter in which an outer portion of the rotatable filter includes pleated media configured to make contact with an agitation flap to facilitate removing dust from the pleated media via a rotation of the rotatable filter. Various other aspects of this apparatus are also contemplated. For instance, the vacuum motor may be configured to remain stationary during the rotation of the rotatable filter. The apparatus may also comprise a filter motor configured to power the rotation of the rotatable filter. Furthermore, the rotatable filter may comprise a knob configured to facilitate a manual rotation of the rotatable filter.

In an exemplary embodiment, it should be further appreciated that the motor-in-filter design illustrated in FIGS. 10-14 may be implemented within apparatus 100. For instance, it is contemplated that the saw apparatus 100 may comprise a vacuum source 112 powered by a vacuum motor 612, and a filter 614 coupled to the vacuum source 112, wherein the vacuum motor 612 is housed within the filter 614. Within such embodiment, the apparatus 100 may further comprise a worktable 120 comprising a center slot 122 axially aligned to a circular saw blade 130, wherein the vacuum source 112 is configured to provide a negative pressure beneath the worktable 120 at the center slot 122, and wherein the filter 614 is configured to collect airborne dust drawn by the negative pressure from an area proximate to the center slot 122.

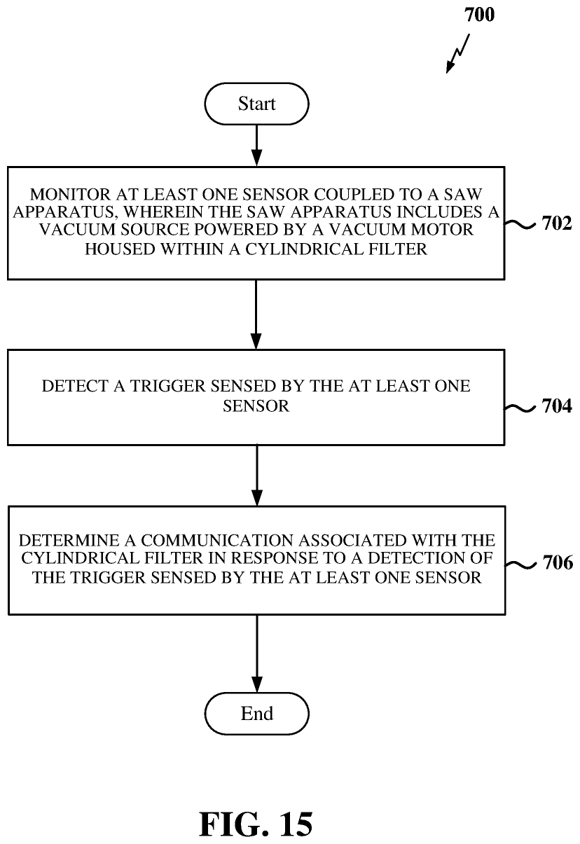

Referring next to FIG. 15, a flow chart illustrating an exemplary method that facilitates monitoring sensors within a saw apparatus according to an embodiment is provided. As illustrated, process 700 includes a series of acts that may be performed by a management system that includes at least one computing device (e.g., management system 300) according to an aspect of the subject specification. For instance, process 700 may be implemented by employing a processor to execute computer executable instructions stored on a computer readable storage medium to implement the series of acts. In another embodiment, a computer-readable storage medium comprising code for causing at least one computer to implement the acts of process 700 is contemplated.

In an aspect, process 700 begins at act 702 with the management system 300 monitoring at least one sensor coupled to a saw apparatus, wherein the saw apparatus includes a vacuum source powered by a vacuum motor housed within a cylindrical filter. Process 700 then proceeds to act 704 where the management system 300 detects a trigger sensed by the at least one sensor, and then concludes at act 706 where the management system 300 determines a communication associated with the cylindrical filter in response to a detection of the trigger sensed by the at least one sensor.

Various other aspects of process 700 are also contemplated. For instance, in addition to contemplating any of various triggers (e.g., wherein the trigger is a threshold number of uses; a threshold amount of use time; and/or a threshold negative pressure level in a negative pressure region within the saw apparatus), any of various types of communications are contemplated. For example, the communication may be an indication to clean or replace the cylindrical filter, wherein process 700 may further comprise transmitting the indication to a remote entity via a network protocol. In another aspect, the communication may be an instruction to the saw apparatus to perform an auto-rotation of the cylindrical filter, wherein an outer portion of the cylindrical filter comprises pleated media configured to make contact with an agitation flap to facilitate removing dust from the pleated media via the auto-rotation of the cylindrical filter.

### Exemplary Integrated Portability Mechanism Embodiments

Conventional masonry and stone cutting saws with 20-inch blade capacity are configured to cut through 8-inch-tall masonry or stone materials. Such tools are very heavy (e.g., >500 lbs.) and bulky, however, which often require special equipment to move (e.g., forklifts). Moreover, the lack of portability of such tools often requires that the tool remain stationary and that the masonry/stone piece be brought to the tool, which is not always feasible or practical. Conventional masonry and stone cutting saws that are deemed “portable” are typically smaller (e.g., equipped with a 14-inch blade), and do not have the same cutting capacity as a 20-inch masonry and stone cutting saw, which is usually much larger.

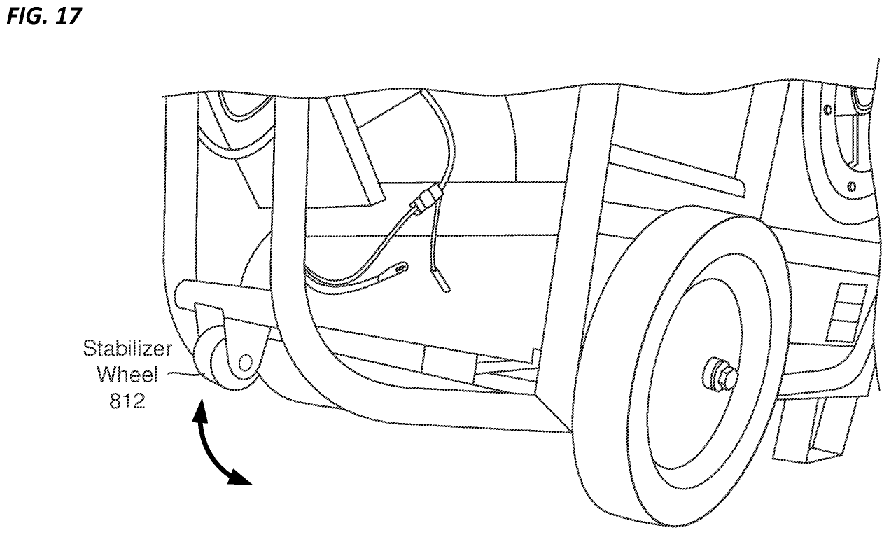

Various disclosed aspects are directed towards a portable heavy-duty cutting saw tool (e.g., equipped with a 20-inch masonry/stone saw), as illustrated in FIGS. 16-17. In a particular embodiment, an integrated system with lightweight components is contemplated, wherein the entire apparatus 800 has a target weight of approximately 350 lbs. or less. For instance, such integrated portability may include utilizing a tube frame on wheels 810 with durable plastic housings surrounding various components of the saw tool (e.g., an integrated dust collection vacuum system within the saw tool). It is also contemplated that components that facilitate portability may be integrated with the saw tool (e.g., forklift pockets 820 and/or a central lift point 830 to facilitate portability across rough terrain, and also makes the saw tool easy to load and unload for transportation).

In another aspect, a three-wheeled configuration is contemplated, wherein the weight distribution of the saw tool 800 facilitates leaning the saw tool 800 towards a stabilizer wheel 812 for easy portability across rough terrain. For instance, in FIG. 17, an exemplary schematic is provided illustrating apparatus 800 in a resting position (i.e., where stabilizer wheel 812 is elevated from the surface). Here, it is contemplated that apparatus 800 may be configured to lean back so that stabilizer wheel 812 makes contact with the surface to facilitate rolling apparatus to a desired location. In general, to achieve an overall lightweight design, it is contemplated that various lightweight components may be utilized including, for example, lightweight motors, housings and structure with 20-inch blade cutting capacity.

In an exemplary embodiment, it should be appreciated that the integrated portability design illustrated in FIGS. 16-17 may be implemented within apparatus 100. For instance, it is contemplated that the saw apparatus 100 may comprise a vacuum source 112 and a worktable 120 comprising a center slot 122 axially aligned to a circular saw blade 130, wherein the vacuum source 112 is configured to provide a negative pressure beneath the worktable 120 at the center slot 122. The apparatus 100 may then further comprise a portability mechanism (e.g., wheels 810, stabilizer wheel 812, forklift pockets 820, and/or lift point 830) integrated within the saw apparatus 100, wherein dimensions associated with the portability mechanism depend on a location of a center of mass of the saw apparatus 100.

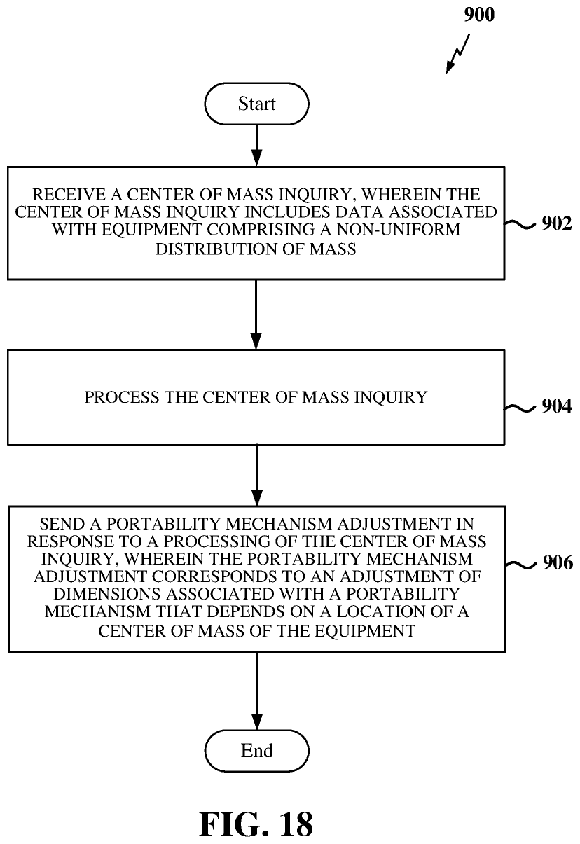

Referring next to FIG. 18, a flow chart illustrating an exemplary method that facilitates ascertaining a portability mechanism adjustment according to an embodiment is provided. Indeed, it is contemplated that any of the portability mechanisms of apparatus 800 (e.g., stabilizer wheel 812, forklift pockets 820, and/or a central lift point 830) may be adjustable to account for varying types of equipment coupled to apparatus 800 that may have varying non-uniform distributions of mass. As illustrated, process 900 includes a series of acts that may be performed by a management system that includes at least one computing device (e.g., management system 300) according to an aspect of the subject specification. For instance, process 900 may be implemented by employing a processor to execute computer executable instructions stored on a computer readable storage medium to implement the series of acts. In another embodiment, a computer-readable storage medium comprising code for causing at least one computer to implement the acts of process 900 is contemplated.

In an aspect, process 900 begins at act 902 with the management system 300 receiving a center of mass inquiry, wherein the center of mass inquiry includes data associated with equipment comprising a non-uniform distribution of mass. Process 900 then proceeds to act 904 where the management system 300 processes the center of mass inquiry, and then concludes at act 906 where the management system 300 send a portability mechanism adjustment in response to a processing of the center of mass inquiry, wherein the portability mechanism adjustment corresponds to an adjustment of dimensions associated with a portability mechanism that depends on a location of a center of mass of the equipment.

Various other aspects of process 900 are also contemplated. For instance, as previously stated, it is contemplated that any of the portability mechanisms of apparatus 800 (e.g., stabilizer wheel 812, forklift pockets 820, and/or a central lift point 830) may be adjustable. The stabilizer wheel 812 may be adjustable so that it locks at a higher or lower height to accommodate for different centers of mass. The forklift pockets 820 may be configured to widen and or slide to a side to accommodate for different centers of mass. The central lift point 830 may be configured to bend up or down to accommodate for different centers of mass. To this end, it should be further appreciated that the processing of the center of mass inquiry at act 904 can be with respect to equipment known by the management system 300 (e.g., known by a manufacturer), wherein the calculations of their center of mass are already known, and wherein their corresponding portability mechanism adjustments are also known.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

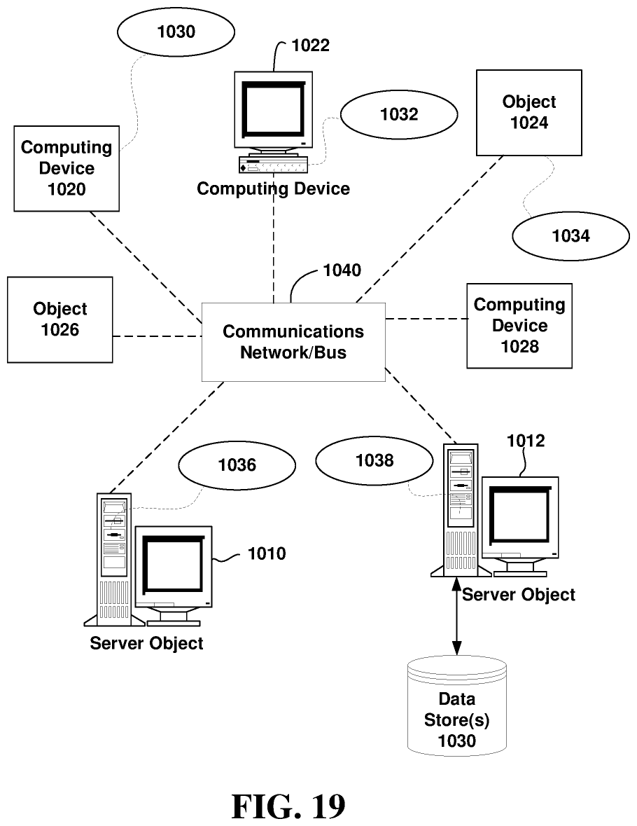

FIG. 19 provides a non-limiting schematic diagram of an exemplary networked or distributed computing environment. The distributed computing environment comprises computing objects or devices 1010, 1012, etc. and computing objects or devices 1020, 1022, 1024, 1026, 1028, etc., which may include programs, methods, data stores, programmable logic, etc., as represented by applications 1030, 1032, 1034, 1036, 1038. It can be appreciated that computing objects or devices 1010, 1012, etc. and computing objects or devices 1020, 1022, 1024, 1026, 1028, etc. may comprise different devices, such as PDAs (personal digital assistants), audio/video devices, mobile phones, MP3 players, laptops, etc.

Each computing object or device 1010, 1012, etc. and computing objects or devices 1020, 1022, 1024, 1026, 1028, etc. can communicate with one or more other computing objects or devices 1010, 1012, etc. and computing objects or devices 1020, 1022, 1024, 1026, 1028, etc. by way of the communications network 1040, either directly or indirectly. Even though illustrated as a single element in FIG. 19, network 1040 may comprise other computing objects and computing devices that provide services to the system of FIG. 19, and/or may represent multiple interconnected networks, which are not shown. Each computing object or device 1010, 1012, etc. or 1020, 1022, 1024, 1026, 1028, etc. can also contain an application, such as applications 1030, 1032, 1034, 1036, 1038, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 19, as a non-limiting example, computing objects or devices 1020, 1022, 1024, 1026, 1028, etc. can be thought of as clients and computing objects or devices 1010, 1012, etc. can be thought of as servers where computing objects or devices 1010, 1012, etc. provide data services, such as receiving data from computing objects or devices 1020, 1022, 1024, 1026, 1028, etc., storing of data, processing of data, transmitting data to computing objects or devices 1020, 1022, 1024, 1026, 1028, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1040 is the Internet, for example, the computing objects or devices 1010, 1012, etc. can be Web servers with which the computing objects or devices 1020, 1022, 1024, 1026, 1028, etc. communicate via any of a number of known protocols, such as HTTP. As mentioned, computing objects or devices 1010, 1012, etc. may also serve as computing objects or devices 1020, 1022, 1024, 1026, 1028, etc., or vice versa, as may be characteristic of a distributed computing environment.

### Exemplary Computing Device

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general purpose remote computer described below in FIG. 20 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 20 thus illustrates an example of a suitable computing system environment 1100 in which one or more of the embodiments may be implemented, although as made clear above, the computing system environment 1100 is only one example of a suitable computing environment and is not intended to suggest any limitation as to the scope of use or functionality of any of the embodiments. The computing environment 1100 is not to be interpreted as having any dependency or requirement relating to any one or combination of components illustrated in the exemplary operating environment 1100.

With reference to FIG. 20, an exemplary remote device for implementing one or more embodiments herein can include a general purpose computing device in the form of a handheld computer 1110. Components of handheld computer 1110 may include, but are not limited to, a processing unit 1120, a system memory 1130, and a system bus 1121 that couples various system components including the system memory to the processing unit 1120.

Computer 1110 typically includes a variety of computer readable media and can be any available media that can be accessed by computer 1110. The system memory 1130 may include computer storage media in the form of volatile and/or nonvolatile memory such as read only memory (ROM) and/or random access memory (RAM). By way of example, and not limitation, memory 1130 may also include an operating system, application programs, other program modules, and program data.

A user may enter commands and information into the computer 1110 through input devices 1140 A monitor or other type of display device is also connected to the system bus 1121 via an interface, such as output interface 1150. In addition to a monitor, computers may also include other peripheral output devices such as speakers and a printer, which may be connected through output interface 1150.

The computer 1110 may operate in a networked or distributed environment using logical connections to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 20 include a network 1171, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components coupled to other components rather than included within parent components (hierarchical). Additionally, it is noted that one or more components may be combined into a single component providing aggregate functionality or divided into several separate sub-components, and any one or more middle layers may be provided to couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the various figures. While for purposes of simplicity of explanation, the methodologies are described as a series of steps, it is to be understood and appreciated that the disclosed subject matter is not limited by the order of the steps, as some steps may occur in different orders and/or concurrently with other steps from what is described herein. Moreover, not all disclosed steps may be required to implement the methodologies described hereinafter.

While the various embodiments have been described in connection with the exemplary embodiments of the various figures, it is to be understood that other similar embodiments may be used or modifications and additions may be made to the described embodiment for performing the same function without deviating there from. Therefore, the present invention should not be limited to any single embodiment.

1. A saw apparatus comprising:
a vacuum source;
a worktable comprising a center slot axially aligned to a circular saw blade, wherein the vacuum source is configured to provide a negative pressure beneath the worktable at the center slot; and
a portability mechanism integrated within the saw apparatus, wherein dimensions associated with the portability mechanism depend on a location of a center of mass of the saw apparatus.

2. The saw apparatus of claim 1, wherein the portability mechanism comprises a plurality of wheels configured to roll on a surface, and wherein at least one of the plurality of wheels is elevated from the surface in a resting position and makes contact with the surface in a moving position.

3. The saw apparatus of claim 2, wherein the at least one of the plurality of wheels is configured to have a variable height.

4. The saw apparatus of claim 1, wherein the portability mechanism comprises a forklift pocket.

5. The saw apparatus of claim 4, wherein the forklift pocket is configured to have a variable width.

6. The saw apparatus of claim 1, wherein the portability mechanism comprises a lift point.

7. The saw apparatus of claim 6, wherein the lift point is configured to have a variable bend.

8. A method, comprising:
employing a processor to execute computer executable instructions stored on a computer readable storage medium to implement the following acts:
receive a center of mass inquiry, wherein the center of mass inquiry includes data associated with equipment comprising a non-uniform distribution of mass;
process the center of mass inquiry; and
send a portability mechanism adjustment in response to a processing of the center of mass inquiry, wherein the portability mechanism adjustment corresponds to an adjustment of dimensions associated with a portability mechanism that depends on a location of a center of mass of the equipment.

9. The method of claim 8, further comprising the act of storing known portability mechanism adjustments associated with particular equipment comprising a non-uniform distribution of mass.

10. The method of claim 8, wherein the portability mechanism adjustment is associated with a variable height of a stabilizer wheel.

11. The method of claim 8, wherein the portability mechanism adjustment is associated with a variable width of a forklift pocket.

12. The method of claim 8, wherein the portability mechanism adjustment is associated with a variable bend of a lift point.
